(19) United States
(12) Patent Application Publication
(10) Pub. No.: US 2025/0005652 A1
(43) Pub. Date: Jan. 2, 2025

(54) USING DIFFERENT DATA SOURCES FOR DETERMINING AND PRESENTING A PATH FOR OBTAINING ITEMS

(71) Applicant: International Business Machines Corporation, Armonk, NY (US)

(72) Inventors: Mauro MARZORATI, Lutz, FL (US); Jeremy R. FOX, Georgetown, TX (US); Carolina GARCIA DELGADO, Zapopan (MX); Trudy L. HEWITT, Cary, NC (US)

(21) Appl. No.: 18/346,183

(22) Filed: Jun. 30, 2023

(51) Int. Cl. G06Q 30/0601

(52) U.S. Cl. CPC G06Q 30/0639; G06Q 30/0631; G06Q 50/01

(57) ABSTRACT

A device may determine one or more preference factors associated with a user moving within a geographical area to obtain a first item and a second item. The device may determine one or more urgency factors associated with obtaining the first item and the second item. The device may select first candidate locations for the first item, and second candidate locations for the second item. The device may analyze path finding factors that include a predicted location of the user at a target date and time set for obtaining the first item and the second item, the one or more urgency factors, the one or more preference factors, and the one or more first candidate locations and the one or more second candidate locations. The device may determine, based on analyzing the path finding factors, a path for the user to obtain the first item then the second item.

### BACKGROUND

The present invention relates to evaluation of different approaches to a user using a mobile device to obtain items within a geographical area. An application, on the mobile device, can provide the user with information and analysis about obtaining the items from a variety of sources. Because of the multitude of different available sources and different preferences of the user, receiving useful analysis presented in a way so as to not overwhelm the user with information can be challenging.

### SUMMARY

In some implementations, a method includes determining, by a device, one or more preference factors associated with a user moving within a geographical area to obtain at least two items including a first item and a second item; determining, by the device, one or more urgency factors associated with obtaining the first item and the second item; selecting, by the device, one or more first candidate locations for the first item, and one or more second candidate locations for the second item; analyzing, by the device, path finding factors that include: a predicted location of the user at a target date and time set for obtaining the first item and the second item, the one or more urgency factors, the one or more preference factors, and the one or more first candidate locations and the one or more second candidate locations; determining, by the device, based on analyzing the path finding factors, a path for the user to obtain the first item then the second item; and communicating, by the device, path information identifying the path to a mobile device associated with the user. The path is from the predicted location of the user to locations of the first item and the second item

In some implementations, a system includes one or more devices configured to: determine one or more preferences associated with a user moving within the geographical area to obtain at least two items including a first item and a second item; determine a level of urgency regarding obtaining the first item and the second item from a first location and a second location, respectively, within the geographical area, analyze, using a machine learning model, path finding factors relating to obtaining the first item and the second item, with the path finding factors including the first location relative to the user, the second location relative to the user, the level of urgency, the one or more preferences associated with the user, and respective characteristics of the first location and the second location; determine, based on analyzing the path finding factors, a path for obtaining the first item and the second item from the first location and the second location within the geographical area; and cause, a mobile device associated with the user, to display a visualization of the path.

In some implementations, a computer program product comprising: one or more computer readable storage media, and program instructions collectively stored on the one or more computer readable storage media, the program instructions comprising: program instructions to determine, for a user, a consumption preference and a level of urgency associated with obtaining a first good from a first location and a second good from a second location, program instructions to analyze factors that include: travel times determined for travel among locations that include a location of the user, the first location, and the second location, and the consumption preference, and the level of urgency, program instructions to determine, based on analyzing the factors, that the first good is to be obtained from the first location and that the second good is to be obtained from the second location; program instructions to determine, based on analyzing the factors, one or more routes for the user to sequentially travel from the location of the user to the first location and the second location; and program instructions to display a visualization that identifies the one or more routes along with one or more predicted benefits associated with the user utilizing the one or more routes.

### BRIEF DESCRIPTION OF THE DRAWINGS

FIGS. 1A-1G are diagrams of an example implementation described herein.

FIG. 2 is a diagram of an example computing environment in which systems and/or methods described herein may be implemented.

FIG. 3 is a diagram of example components of one or more devices of FIGS. 1 and 2.

FIG. 4 is a flowchart of an example process associated with using different data sources for determining and presenting a path for obtaining items by a user.

### DETAILED DESCRIPTION

The following detailed description of example implementations refers to the accompanying drawings. The same reference numbers in different drawings may identify the same or similar elements.

A user, guided by information provided by mobile devices, can move within a geographic area to obtain different items (e.g., goods and services). Many different factors can influence the actions taken by the user to obtain items. As used herein, “mapping” can broadly refer to guidance provided by a mobile device that graphically identifies, on a map of different locations, where an item can be obtained, as well as a potential paths for navigation among the different locations.

In some circumstances, independent of the guidance provided by mobile devices, the user may act based on other factors beyond those provided by mobile device applications of the mobile device (e.g., the user may act based on scheduled events that can affect the need for different items). In addition, the user can have a variety of preference factors for items and for navigating to obtain the items. In some circumstances, multiple items can be sought by the user, and instead of selecting sources of one item at time, there is a need for information associated with obtaining a combination of two or more items from a geographic area.

In addition to locating and analyzing information associated with obtaining items, the mobile device applications need a way to present information to the user with enough detail that decisions may be facilitated, but not too much detail that the user is overloaded with information.

When the user accesses some mobile device applications regarding obtaining multiple items, the mobile device applications may require multiple independent inquiries from the user. Based on the multiple independent inquiries, results (of each independent inquiry) are serially provided to the mobile device applications. The results may appear to be unconnected results and the mobile device applications are unable to fit the seemingly unconnected results together into a coherent strategy for obtaining the items. Obtaining results when multiple inquiries have to be made can be complicated when combined with the additional considerations noted above (such as scheduled events, changing preference factors for items and circumstances for obtaining items, and/or other factors personal to the user). As used herein, the term “items” is intended to be broadly construed as things to be obtained by the user (e.g., goods and/or products).

As a result of the approach described above, instead of the mobile device applications providing guidance with a unified strategy, multiple inquiries may need to be transmitted (using the mobile device) to facilitate the consideration of multiple independent inquiries from the user (e.g., to facilitate the consideration of information regarding items, locations, and services). Transmitting multiple inquiries in this manner consumes computing resources, network resources, and/or storage resources of the mobile device.

Additionally, transmitting multiple inquiries in this manner lead to multiple sets of results that have to be combined by the mobile device applications and interpreted by the user. Moreover, when multiple items and paths to obtain items are considered, visualizations of data (provided about obtaining the items) may not be displayed in a way that reflects the many personal and circumstantial factors considered by the user when selecting an approach to obtaining the items. An example search, where personal and circumstantial factors may be considered, involves the user requesting information in furtherance of a demanding task, such as preparing for a wedding, a trip, and/or a graduation, among other similar tasks. In this regard, these demanding tasks have a significance that can affect the results of an inquiry with respect to quality of the items and time for obtaining the times. For example, these demanding tasks may be associated with above average quality for the items sought and a short time for obtaining the items.

For the foregoing reasons, searching for different locations for obtaining the items in the geographic consumes computing resources, network resources, and/or storage resources of the mobile devices. Moreover, transmitting and responding to the multiple inquiries as described above wastes computing resources, network resources, and other resources.

Some implementations described herein enable the analysis of combinations of factors to identify candidate locations for obtaining items. As used herein, a “candidate location” can broadly refer to an entity or an establishment identified as a location of a potential source for obtaining the items. Factors considered are described below, and include user preferences, urgency, and/or distances between candidate locations. Once the candidate locations for obtaining one or more of the items are identified, the combination of factors can be further utilized to determine a path to obtain the items (e.g., the path to navigate to locations of the items).

In some implementations, when requesting a recommendation for obtaining multiple items from mobile device applications of a mobile device, integrated results can be generated by the mobile device and presented to the user of the mobile device based on obtaining the multiple items in the path from one location to another location. In addition, implementations described herein may provide visualizations that facilitate presentation of the integrated results as the path determined based on the combinations of factors described herein. As used herein, a visualization broadly refer to graphical representations of information generated by the mobile device.

Based on an analysis of combinations of data sources associated with obtaining of the items, multiple inquiries by the mobile device can be avoided. Different data sources include sources of scheduling content, sources of social media content, sources of historical content, as well as public sources of information about the candidate locations.

After analyzing the combination of data sources, some implementations may generate and provide a combination of integrated results and visualizations in a manner that may preserve computing resources, network resources, and other resources that would have otherwise been used by the mobile device to submit multiple inquiries about individual items to be obtained. In addition, approaches to collecting, analyzing, and presenting data about obtaining different items described herein may improve the user experience by considering different data sources and presenting the results to the user in a fashion that is easy to understand and utilize.

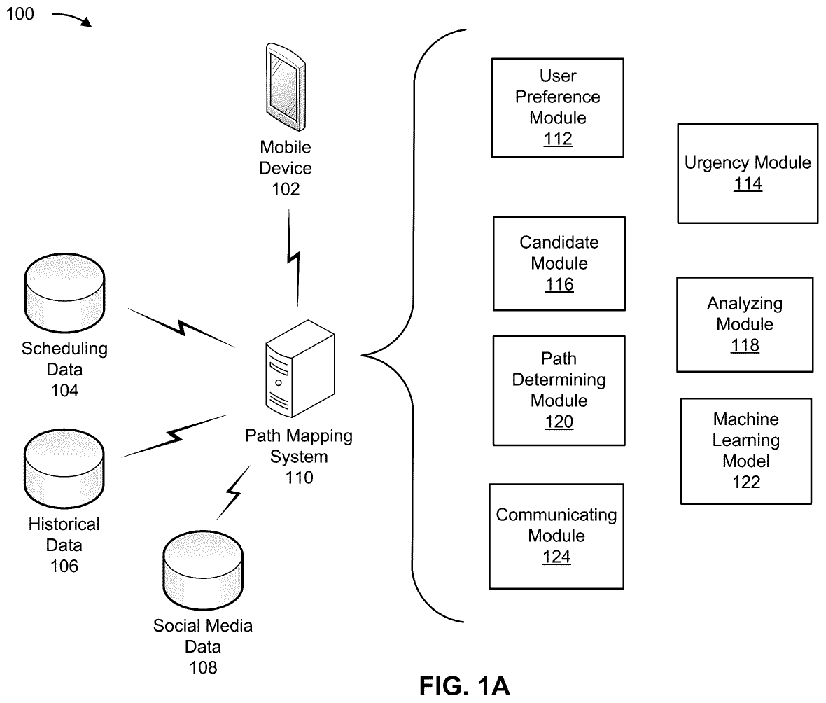

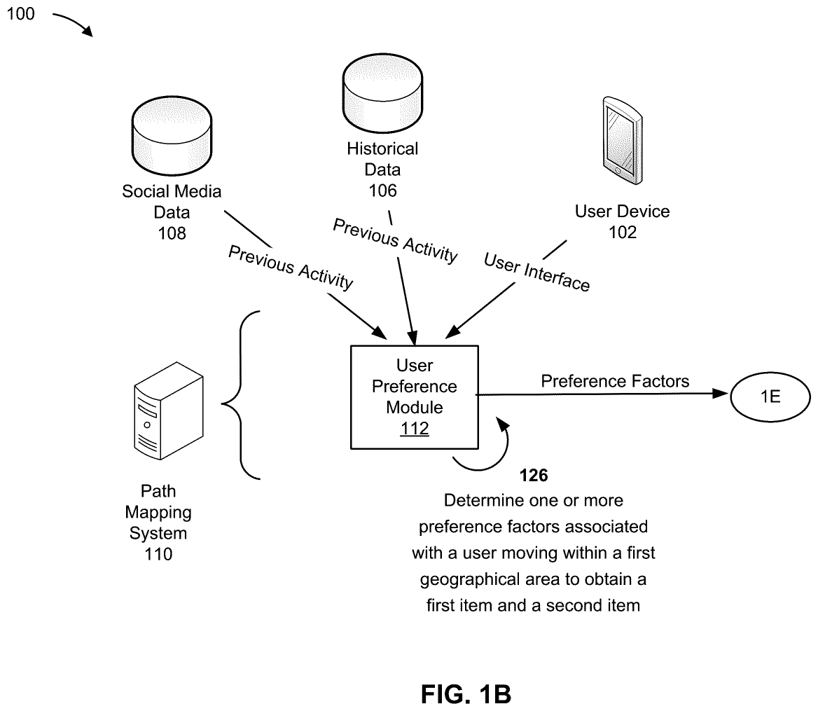

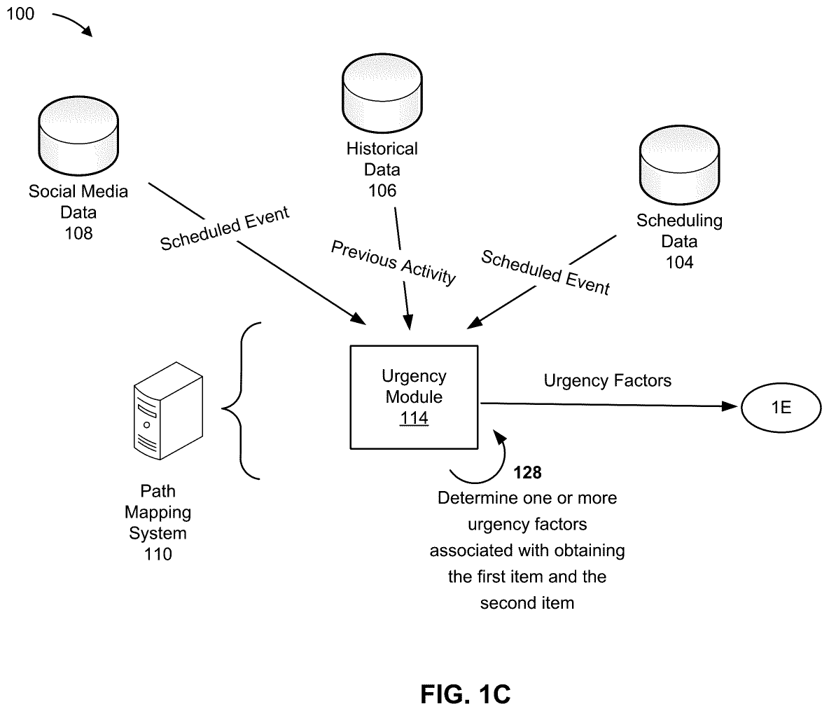

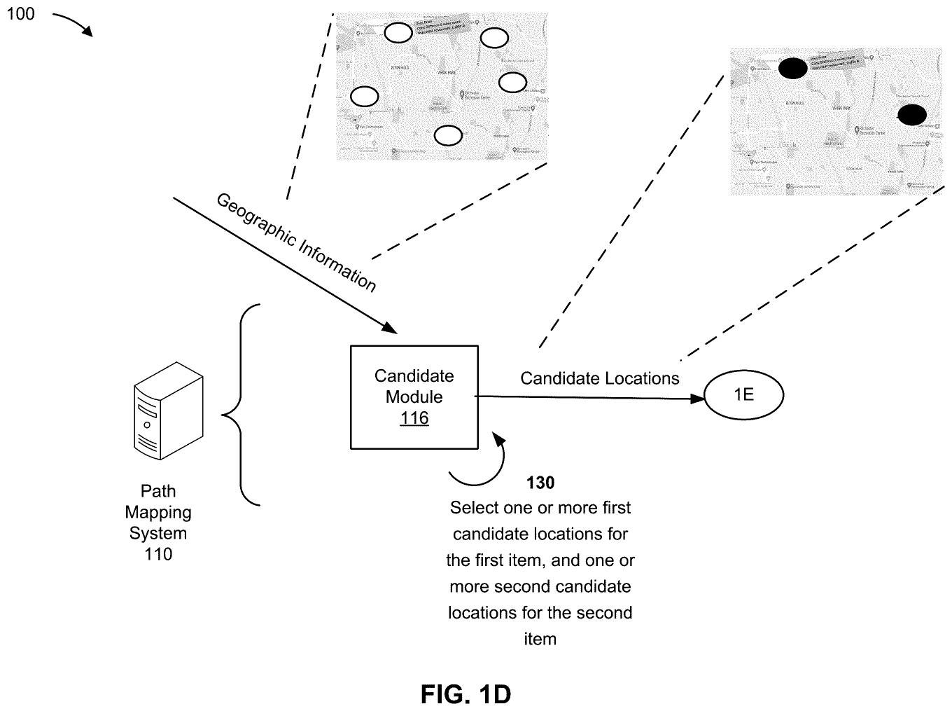

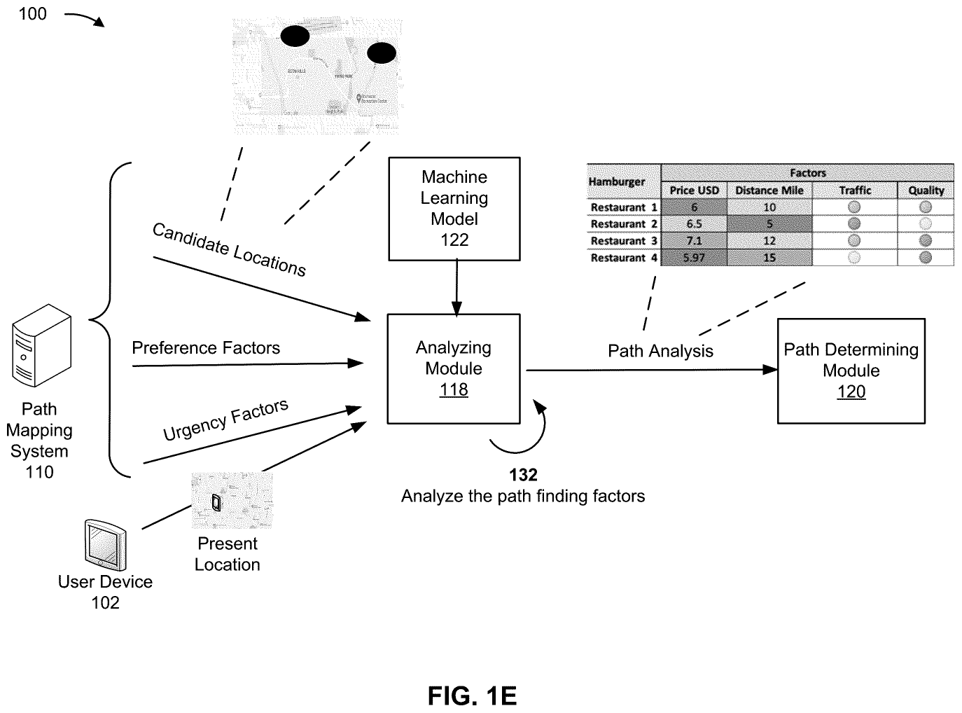

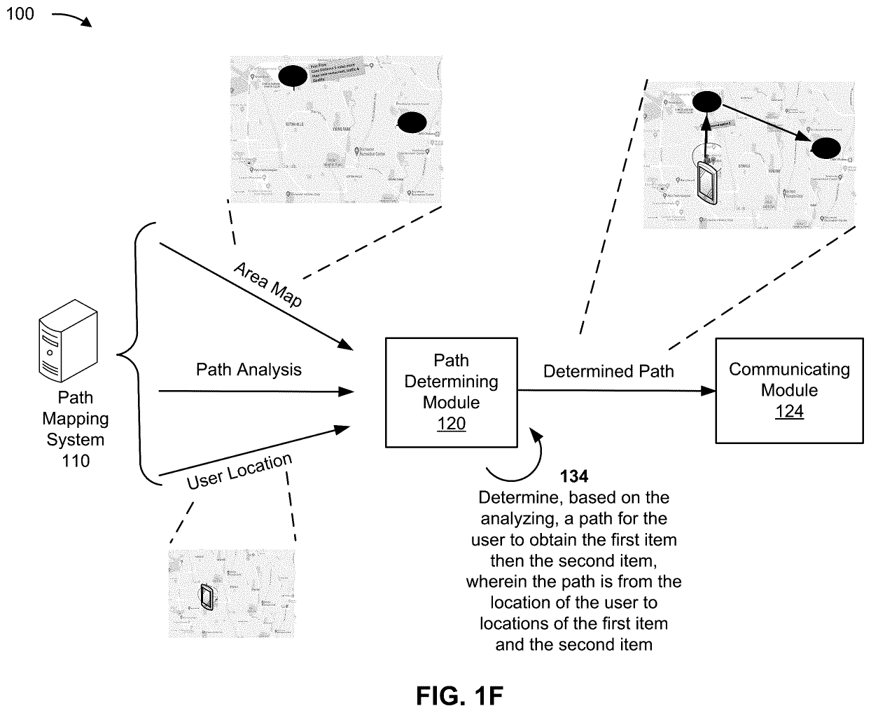

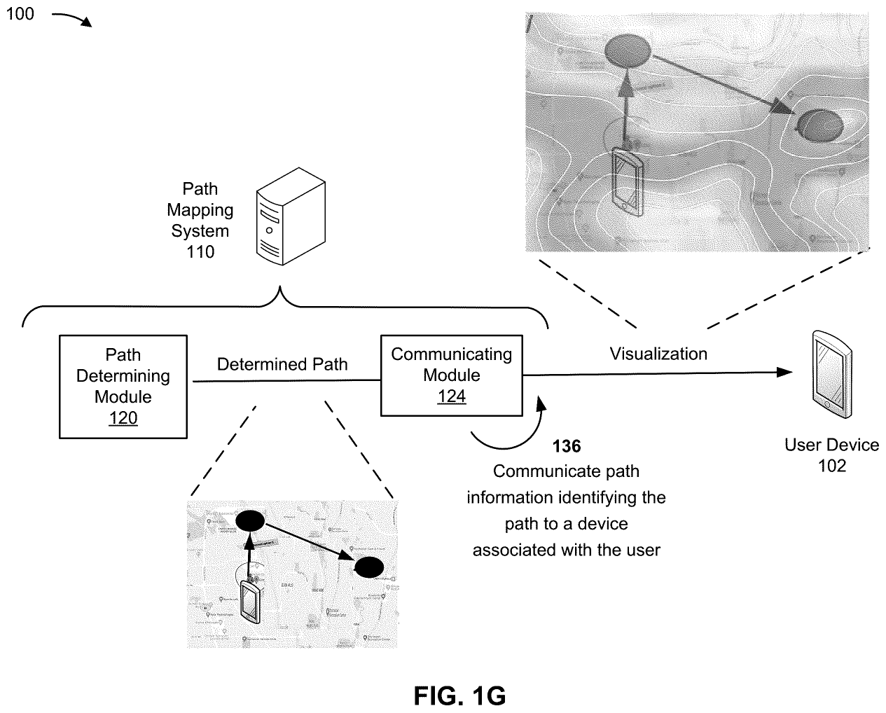

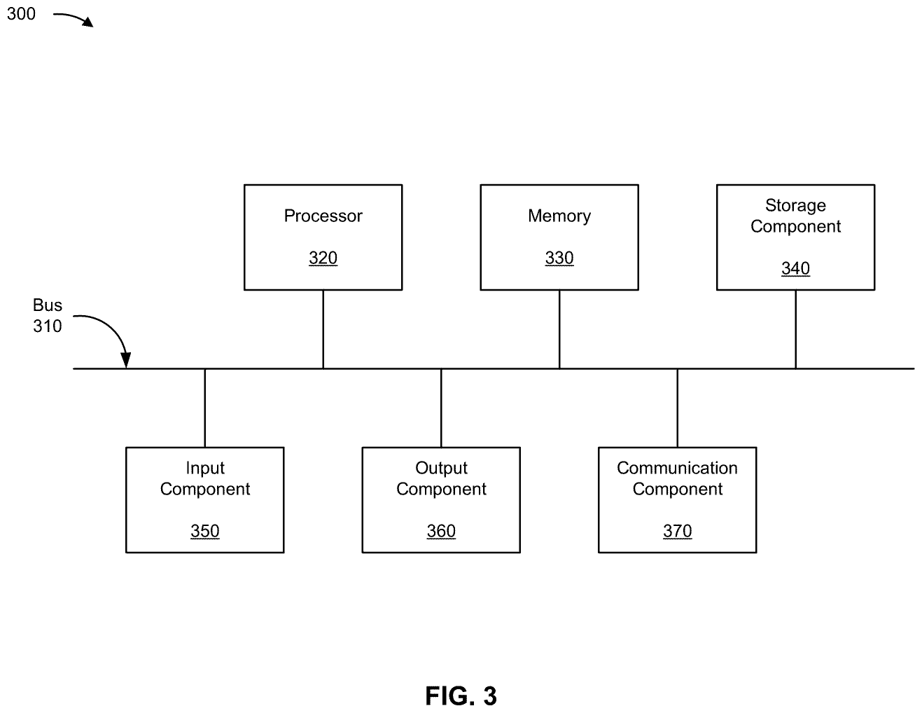

FIGS. 1A-1G are diagrams of an example implementation 100 described herein. As shown in FIGS. 1A-1G, example implementation 100 includes mobile device 102 of a user, scheduling data 104, historical data 106, social media data 108, and path mapping system 110. These devices are described in more detail below in connection with FIG. 3. In the description to follow and merely as an example, the user may utilize mobile device 102 to receive path information identifying a path for obtaining multiple items from a geographical area. The path information may be received from path mapping system 110.

The devices may be connected via a network that includes one or more wired and/or wireless networks. For example, the network may include Ethernet switches. Additionally, or alternatively, the network may include a cellular network, a public land mobile network (PLMN), a local area network (LAN), a wide area network (WAN), a private network, the Internet, and/or a combination of these or other types of networks. The network enables communication between mobile device 102, scheduling data 104, historical data 106, social media data 108, and path mapping system 110, and/or one or more additional devices associated with path mapping system 110.

Mobile device 102 may include one or more devices configured to receive, generate, store, process, and/or provide information associated with providing data from path mapping system 110, as explained herein. Mobile device 102 may include a communication device and a computing device. For example, mobile device 102 may include a wireless communication device, a mobile phone, a user equipment, a laptop computer, a tablet computer, a desktop computer, or a similar type of device.

Scheduling data 104 may include one or more devices configured to receive, generate, store, process, and/or provide scheduling content associated with the user of mobile device 102. As used herein, scheduling data 104 includes a device or collection of devices that may store scheduling content for retrieval. As discussed further below, this scheduling content can be analyzed by path mapping system 110 to determine the path for the user to obtain a first item then a second item within a geographical area, as explained herein. For example, scheduling data 104 can be accessed with permission of the user and used by path mapping system 110 to identify upcoming events that can affect the user obtaining the items.

Historical data 106 may include one or more devices configured to receive, generate, store, process, and/or provide historical content associated with the user of mobile device 102. As used herein, historical data 106 includes a device or collection of devices that may store historical content for retrieval. As discussed further below, this historical content can be analyzed by path mapping system 110 to determine the path for the user to obtain the first item then the second item within the geographical area, as explained herein. In some implementations, historical content can include records of prior purchases, travels, events, and/or other data that can affect the obtaining of the items.

Social media data 108 may include one or more devices configured to receive, generate, store, process, and/or provide social media content associated with the user of mobile device 102. As used herein, social media data 108 includes a device or collection of devices that may store the social media content for retrieval. As used herein, “social media content” is intended to be broadly construed as information provided by the user for presentation by different online services. The online services may include photo-sharing websites, short message posting websites, websites for scheduling content that includes activities among interested individuals, and/or other websites than can provide information similar to the relevant information described herein.

As discussed further below, this social media content can be analyzed by path mapping system 110 to determine the path for the user to obtain the first item then the second item within the geographical area, as explained herein. For example, when a profile of a social media user includes a disclosure of an upcoming event, or a user preference, this disclosure can be analyzed by path mapping system 110 and content of the disclosure posted by the social media user can be used to update different factors associated with obtaining the items. For example, when a social media user (who has extensive connections with the user) posts a review of an item or a source of item, this information can be analyzed to determine which, if any, preference factors are implicated based on the posted review of the item or the source of the item. That is, when the post described how low the traffic congestion was when traveling to the source of the item, the preference factor that prefers low traffic congestion can be applied to this report of low congestion. As used herein, “preference factors” can be broadly construed equivalent to user preferences, (e.g., different considerations, associated with the user, that can influence the actions taken by the user to obtain different items).

Path mapping system 110 may include one or more devices configured to receive, generate, store, process, and/or provide information associated with determining the path for the user to obtain the first item then the second item within the geographical area, as explained herein. In some examples, to determine the path, path mapping system 110 may be configured to analyze path finding factors. In some examples, the path finding factors may include a predicted location of the user at a target date and time set for obtaining the first item and the second item, one or more urgency factors associated with obtaining the first item and the second item, one or more preference factors associated with the user moving within a geographical area to obtain the first item and the second item, and one or more candidate locations within the geographic area for obtaining the first item and the second item.

As shown in FIG. 1A, path mapping system 110 includes user preference module 112, urgency module 114, candidate module 116, analyzing module 118, path determining module 120, machine learning model 122, and communicating module 124.

User preference module 112 may include one or more devices configured to determine one or more preference factors associated with the user moving within the geographical area to obtain the first item and the second item. In some implementations, user preference module 112 of path mapping system 110 may determine one or more preference factors associated with the user by receiving scheduling content from scheduling data 104, historical content from historical data 106, social media content from social media data 108, and/or other sources that can be a part of information considered by user preference module 112 to determine preference factors.

Urgency module 114 may include one or more devices configured to determine one or more urgency factors associated with obtaining the first item and the second item. As used herein, “urgency factors” can broadly refer to different considerations that may cause the user to have a level of motivation to obtain sought after items that exceeds a threshold level of motivation. In some implementations, path mapping system 110 may determine one or more urgency factors associated with mobile device 102 by receiving respective content from scheduling data 104, historical data 106, social media data 108, and/or other sources that can be a part of information considered by user preference module 112 to determine urgency factors.

Candidate module 116 may include one or more devices configured to select one or more first candidate locations for the first item, and one or more second candidate locations for the second item. In some implementations, candidate module 116 of path mapping system 110 may determine candidate locations for the first item and the second item based on information about the geographic area.

Analyzing module 118 may include one or more devices configured to analyze the path finding factors, such as a predicted location of the user at a target date and time set for obtaining the first item and the second item, the one or more urgency factors, the one or more preference factors, the one or more first candidate locations, and the one or more second candidate locations. In some implementations, analyzing module 118 may analyze factors that include the predicted location of the user at the target date and time set for obtaining the first item and the second item. Stated differently, analyzing module 118 may analyze factors to provide results in real-time or near real-time, based on a current location of mobile device 102. Additionally, or alternatively, analyzing module 118 may analyze factors to provide results for obtaining the items at a different location and at a target date and time, in the future, set for obtaining the items. Additional factors that can be analyzed include, as discussed above, the one or more urgency factors, the one or more preference factors, the one or more first candidate locations, and the one or more second candidate locations.

Path determining module 120 may include one or more devices configured to determine, based on analyzing the path finding factors, the path for the user to obtain the first item then the second item, with the path being from a predicted location of mobile device 102 to locations of the first item and the second item. As used herein, the “path” can broadly refer to data generated by path determining module 120 from various information described herein, that can be used by mobile device 102 to generate a visualization of the results, e.g., mapped locations for obtaining the items, as well as the path that was determined by path determining module 120 to facilitate the obtaining of the items. In an example, path determining module 120 can determine the path by using relevant information described herein to select a route to be used to obtain the items.

Machine learning model 122 may include one or more devices configured to facilitate the analysis performed by analyzing module 118 using machine learning algorithms.

Communicating module 124 may include one or more devices configured to communicate the path information identifying the path to mobile device 102 associated with the user. In an example, communicating module 124 can generate different visualizations of the path generated by path determining module 120.

As shown in FIG. 1B, and by reference number 126, user preference module 112 of path mapping system 110 may determine one or more preference factors associated with the user moving within the geographical area to obtain the first item and the second item. For example, path mapping system 110 may receive an inquiry from mobile device 102 for information about obtaining the first item and the second item. As an example, the first item may be a hamburger and the second item may be a dessert. While the example provided herein has been described using a hamburger and a dessert as the items to be obtained, in other applications, the items may include other types of food, clothing, vehicles, computer, among other examples of items that may be acquired by the user.

Example preference factors determined by user preference module 112 can be associated with the items sought (e.g., brand names, capabilities). Other preference factors can include locations within the geographic area that can provide the item (e.g., a large department store or a small boutique shop). Other preference factors can be associated with the process of obtaining the items, such as the mode of travel used to reach the locations (e.g., a preference for walking to locations and/or a preference for driving to locations). Some preference factors can be associated with changing conditions at locations of the items, such as the weather, the traffic congestion, and the number of people at the locations. Other preference factors that can be associated with changing conditions at locations of the items can be associated with the prices of the items at the locations changing compared to a sensitivity of the user to price changes, and willingness to select a different source based on relative price changes.

In some implementations, preference factors can be obtained from a variety of sources. For example, some preference factors can be identified by analysis of historical content (e.g., brands of items selected by the user and locations where the items were obtained). Other preference factors can be identified by the user via a user interface of mobile device 102. The other preference factors may include user demographics. Other preference factors can be identified by searching and analyzing social media content (e.g., items featured in social media posts by the user, and/or advertisements that were selected by the user for additional information). Preference factors associated with price can be estimated based on user demographics of the user (e.g., age, income level, budget, and other user demographics), as well as historical content associated with the user.

As shown in FIG. 1C, and by reference number 128, urgency module 114 may determine one or more urgency factors associated with obtaining the first item and the second item. For example, path mapping system 110 may determine one or more urgency factors associated with obtaining the hamburger and the dessert. In different examples, urgency factors may be based on a limited amount of time available for obtaining the hamburger and the dessert. For example, the user may not be permitted to be out past 11 PM (e.g., a curfew), and/or there may be a shortage of hamburgers which suggests that hamburgers may not be available after a particular date and/or time. The curfew and the shortage of hamburgers may be urgency factors because they create a sense of urgency with respect to the hamburgers.

In some implementations, different urgency factors can be evaluated by path mapping system 110 to affect the selection of locations for obtaining the first and the second items. For example, when users have urgent commitments in different geographical areas, the urgent commitments can affect the time available for obtaining the first and the second items. This limited time availability can affect the selection of candidate locations and different paths between candidate locations (e.g., because of the time required to traverse distances within the geographical area).

In some implementations, urgency module 114 can utilize data from a variety of sources to determine different urgency factors. For example, in some implementations, scheduling data 104 can be accessed to receive different types of scheduling content (e.g., the schedule of the user can be accessed from a calendaring server).

In some implementations, the different types of scheduling content can be relevant to determining the lengths of suggested paths between candidate locations. For example, when the user accesses mobile device 102 with an inquiry for information for obtaining the items, urgency module 114 may submit a query to the calendar server (e.g., scheduling data 104) to access the schedule of events for the user. As used herein, the term “event” can broadly refer to appointments, meetings, engagements, travel arrangements, and/or other occasions that are scheduled to occur/or occurred at a point in time. Typically, the calendar server synchronizes with mobile device 102. This query submitted by urgency module 114 can return an event scheduled for the user with a comparably high level of urgency, such as a flight scheduled to depart at a time in the relatively near (e.g., two to five hours) future. Alternatively, or additionally, urgency module 114 may submit a query to scheduling data 104 to obtain scheduling content corresponding to a longer term, relatively high urgency event, such as a wedding or a work commitment meeting.

As noted above, urgency module 114 can assess urgency factors associated with obtaining the first and second items. In addition, with respect to characteristics of the items being obtained, some implementations can assess whether the items relate to the cause of the overall urgency of obtaining the items. For example, in a situation where an event scheduled is a wedding reception, and the time of wedding reception is imminent, a designation of one or both of the items to be obtained as gift for the reception can alter many aspects of the path selected by the implementation (e.g., because the items to be obtained are required to attend the event imminently occurring).

In some implementations, urgency module 114 can assess a degree of relation between the scheduled event and obtaining the item (e.g., a gift to be presented at the wedding reception would have a relatively high degree of relation with the scheduled event). Continuing this example, based on these urgency factors, a selection of a distance of the selected path can be lengthened (e.g., to direct the user to a better store than one at a closer distance), or in other circumstances the selection of the distance can be shortened (e.g., because insufficient time is available before the wedding reception commences).

As further depicted in FIG. 1C, urgency module 114 can utilize data from additional sources to determine different urgency factors. For example, in some implementations, historical data 106 can be accessed to receive historical content regarding different types of previous activity of the user. While historical content is noted above as being useful to assess the preference factors of the user for obtaining different items, historical content can also be useful to determine urgency factors.

For example, past activity of the user can facilitate estimating a length of time required to perform different actions (e.g., traveling a particular distance using different modes transportation, and/or a length of time required at a location to obtain a selected item). Additionally, or alternatively, when historical content is accessed by urgency module 114, the historical content can be related to other users who have been in situations similar to the user. This access to crowdsourced behavioral data can provide additional, useful information for use by urgency module 114 in determining urgency factors. For example, the historical content about a geographic area may contain specific travel times for other users that moved within the geographic area at different times, and this data can be relevant to estimating an urgency level for obtaining the item within a particular time frame.

As further depicted in FIG. 1C, urgency module 114 can utilize data from additional sources to determine different urgency factors. For example, in some implementations, social media data 108 can be accessed to receive information regarding different types of previous activity of the user.

With respect to urgency factors collected and analyzed by urgency module 114, in some implementations, a posting from a social media website can be retrieved and analyzed to assess a level of urgency associated with obtaining different items. For example, a posting by the user can state that a particular item is desired and/or is required in a short time frame for a particular reason. Further to this end, responses from other users to different postings can also provide useful urgency information (e.g., recommendations from other users for different items to obtain, a remaining quantity of the items, a limited period of time for obtaining the items, and/or locations for obtaining the items).

As shown in FIG. 1D, and by reference number 130, candidate module 116 may select one or more first candidate locations for the first item, and one or more second candidate locations for the second item. Returning to the hamburger/dessert example, in some implementations, candidate module 116 of path mapping system 110 may access a public source of information about the quality of different restaurants, and select one or more first candidate locations for the hamburger, and one or more second candidate locations for the dessert, based on the quality of different restaurants.

In some implementations, for a particular geographic area, a set of stores can be selected as candidate locations for obtaining the sought after items. To form the set of stores, an evaluation process of stores can be based on different characteristics of the stores (e.g., quality ranking), as well as additional value aspects of the retailer (e.g., return/warranty policy, loyalty rewards/perks, customer service, etc.). As used herein, “quality rankings” can broadly be based on previous customer visits, prices of products, and/or location, among other factors.

In addition, some implementations can use preference factors received from user preference module 112 to assess the significance of the characteristics of the stores. For example, when a store has a particular loyalty program, and the user has a preference for the program, this factor can be evaluated along with other factors to determine whether the location of the store is to be included as a candidate location for a particular item. In addition, some implementations may also evaluate a threshold for which the user is willing to deviate from a loyalty program and change their shopping patterns to use alternate retailers within their geographical location based on lower pricing and/or other considerations (e.g., one retailer has a lower price by $10, but another retainer has a better return policy and offers coupons for 5% back on a next purchase).

As shown in FIG. 1E, and by reference number 132, analyzing module 118 may analyze the path finding factors. For example, analyzing module 118 of path mapping system 110 may analyze a location of the user at a target date and time set for obtaining the first item and the second item, the one or more urgency factors, the one or more preference factors, the one or more first candidate locations, and the one or more second candidate locations. The one or more urgency factors may include an urgency factor associated with a prior commitment on a target date and/or time.

In some implementations, as depicted, analyzing module 118 may receive information from other processes of path mapping system 110 described herein. For example, information identifying candidate locations can be received from candidate module 116, preference factors can be received from user preference module 112, urgency factors can be received from urgency module 114. In addition, up to date information can be received from other sources (e.g., mobile device 102 can provide a current location of mobile device 102). Other information received from mobile device 102 that can be analyzed include additional preference factors (e.g., similar to the preference factors discussed above with FIG. 1B).

Returning to the example in which the user is seeking to the hamburger and the dessert from one or more restaurants in the area. After four restaurants are selected as candidate locations for one or both of the hamburger and dessert, based on the preference factors, analyzing module 118 can evaluate other factors to generate source analysis for use determining the path by path determining module 120. The example preference factors include the respective prices of the hamburger and the dessert, distance in miles of the candidate locations from the current location of mobile device 102, traffic, and the quality of the hamburger and the dessert.

To facilitate the analysis of the candidate locations, analyzing module 118 may utilize machine learning model 122. In some implementations, machine learning model 122 can be generated and maintained to enable the types of multi-dimensional analysis performed by analyzing module 118. In some implementations, machine learning model 122 can be trained using the variety of data described herein along with historical results of different efforts to obtain items by the user and other users. Example training data can include that, at noon, a hamburger and a milkshake were obtained by another user in an hour from different location within a geographical area. Based on this, the model can use this hour completion time to inform analysis of the inquiry for obtaining the hamburger and the milkshake discussed herein.

Continuing this example, based on preference factors that prefer high quality items, low traffic congestion, and not traveling over 10 miles to get a hamburger, restaurants 1 and 2 can be selected from the candidate restaurants 1-4. In this example, the user also wants a milkshake to go with the hamburger. Based on a different sets of data, it can be determined that restaurant 3 could provide the best experience for obtaining the milkshake. Based on this analysis, source analysis can be provided to path determining module 120 that lists recommendations including restaurants 1 and 2 for the first item, and restaurant 3 for the second item.

As shown in FIG. 1F, and by reference number 134, path determining module 120 may determine, based on the analyzing, the path for the user to obtain the first item then the second item. The path is from the location of the user to locations of the first item and the second item.

Continuing the example from above, path determining module 120 may receive the source analysis from analyzing module 118 and combine this analysis with the present location of mobile device 102 and a map of the geographic area. The source analysis generated includes information identifying restaurants 1 and 2 for the first item and information identifying restaurant 3 for the second item. In some implementations, based on the source information obtained from analyzing module 118, the preference factors, and the urgency factors, the path can be determined from the current location of mobile device 102 to restaurant 2, then to restaurant 3. This determined path can be provided to communicating module 124 for the generating of a visualization for mobile device 102.

In addition to the factors noted above, in some implementations, the path finding factors may further include a congestion condition being present at one or both of the first and second locations. An example congestion condition can include traffic congestion, and preference factors can be used to assess the significance of this condition for the selected path (e.g., a preference to avoid traffic congestion can be considered by path determining module 120).

As shown in FIG. 1G, and by reference number 136, communicating module 124 may communicate the path information identifying the path to a device associated with the user. For example, communicating module 124 of path mapping system 110 may communicate, to mobile device 102, the path information selected above for obtaining the hamburger and the dessert.

In some implementations, the path generated can be overlayed on a map and can provide a route between the locations of the first and second items. In some implementations, additional information may be added to the visualization of the results, e.g., based on the complex path finding factors described above.

In some implementations, communicating module 124 generates visualizations that depict sources of different items in relation to a heatmap of overlapping “gravity wells” that can draw the user to other activities (e.g., cheaper beverage this way, cheaper food that way, best service in yet a third way). In some implementations, heatmaps can be generated with colors based on urgency factors and overlayed on other visualizations to provide additional information about where interesting elements may be located in relation to goods sought to be obtained. As used herein, “gravity wells” can broadly refer to mapped focal points within a geographical area that can draw users towards them due to their distinctive offerings.

Another type of data presentation may be used to determine the advantages and disadvantages (pros and cons) of different options for obtaining the hamburger. For example, restaurant (R4) is determined to have the lowest cost hamburger but the distance from the current location of mobile device 102 to R4 is farther than the distance from the current location of mobile device 102 to R3. In addition, public data sources can indicate that vehicle traffic is less congested for travel to R3. Having analyzed the obtaining of the first item, implementations described herein may determine the pros and cons using identified candidate locations for obtaining the dessert.

In addition to performing analysis similar to the pros and cons for the hamburger above, implementations may determine and consider the distances of all the candidate locations (for the first item) from all the candidate locations for the second item. Given the two-part analysis described above, analyzing module 118 can determine an intersection of pros and cons of using a source of the hamburger and a source of the dessert, according to the single criteria, where the pros and cons of the second step (the locations of the second) were influenced by the displacement to the first establishment.

For example, to analyze the quality, congestion, and distance factors for the respective items to be obtained and candidate locations, some implementations described herein can use historical content from historical data 106 or other data sources, to assess the importance of the factors relative to each other. Based on this importance, some implementations described herein can add weights to the evaluation of different factors based on the preference factors. Thus, in this example, quality can be weighted higher than other factors as being important to the user.

In an implementation, a visualization that depicts different combinations of weighted factors can be used to represent both a primary path suggested, as well as factors that could lead the user to switch to different locations for items (e.g., a combination of less congestion, higher quality, and a shorter distance). Based on this visualization of alternatives, some implementations can be configured to automatically update the path based on changes to different factors at the selected locations (e.g., congestion increases at restaurant 2, and is lower at restaurant 1).

Another visualization that can be provided using a heatmap overlay involves a return on investment (ROI) for traveling a particular distance. For example, some implementations may determine the predicted benefit to the user per unit of distance traveled based on factors that include a time associated with traveling the unit of distance traveled, a cost required associated with traveling the unit of distance, modes of travel available for traveling the unit of distance, and/or other factors that can affect benefits and costs to users. Thus, in this example, switching to restaurant 1 from restaurant 2 for the hamburger item, can have a determined ROI based on the change in distance that needs to be traveled, as well as the weighted benefits that are predicted to accrue based on the change. In some implementations, the preference factors and historical content associated with price may be used to determine what threshold of ROI would motivate users to consider an alternate location, e.g., based on pricing. In another visualization, a display of expected benefit per unit distance may be provided by implementations. For example, to have effective selected benefit, Y-distance must be traveled. Other ROI analysis by implementations include an ROI for traveling a distance that is determined based on time, transportation cost, and other factors.

As indicated above, FIGS. 1A-1G are provided as an example. Other examples may differ from what is described with regard to FIGS. 1A-1G. The number and arrangement of devices shown in FIGS. 1A-1G are provided as an example. A network, formed by the devices shown in FIGS. 1A-1G may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

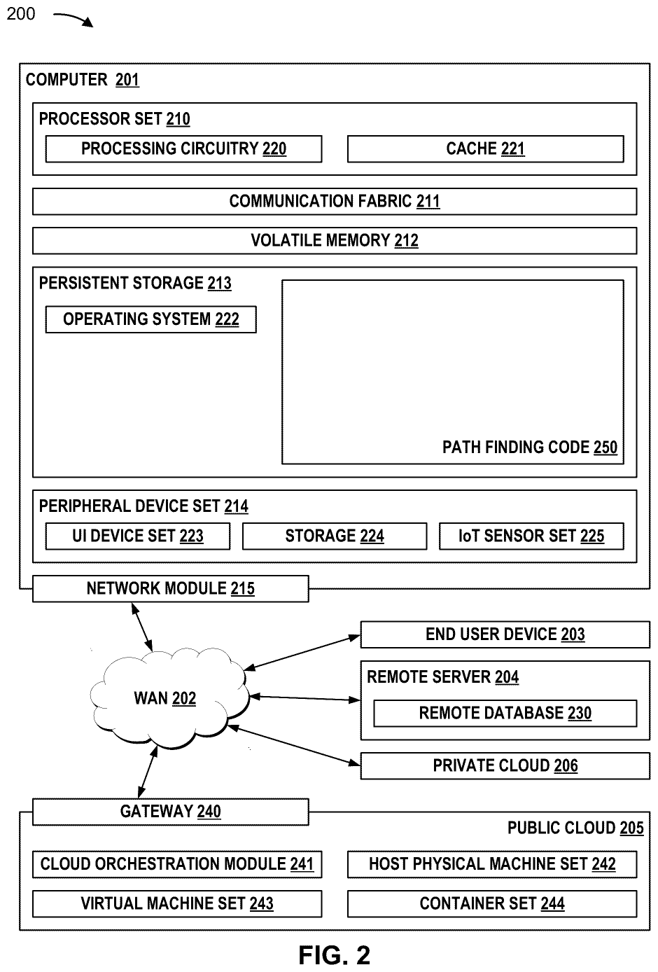

FIG. 2 is a diagram of an example computing environment 200 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 contains an example of an environment for the execution of at least some of the computer code involved in performing the inventive methods, such as path finding code 250. In addition to block 250, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and block 250, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

COMPUTER 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

PROCESSOR SET 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in block 250 in persistent storage 213.

COMMUNICATION FABRIC 211 is the signal conduction path that allows the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

PERSISTENT STORAGE 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid-state storage devices. Operating system 222 may take several forms, such as various known proprietary operating systems or open-source Portable Operating System Interface-type operating systems that employ a kernel. The code included in block 250 typically includes at least some of the computer code involved in performing the inventive methods.

PERIPHERAL DEVICE SET 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

NETWORK MODULE 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 203 is any computer system that is used and controlled by an end user (for example, a customer of an enterprise that operates computer 201) and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

REMOTE SERVER 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

PUBLIC CLOUD 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

FIG. 3 is a diagram of example components of a device 300, which may correspond to mobile device 102 and/or path mapping system 110. In some implementations, mobile device 105 and/or path mapping system 110 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random-access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid-state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

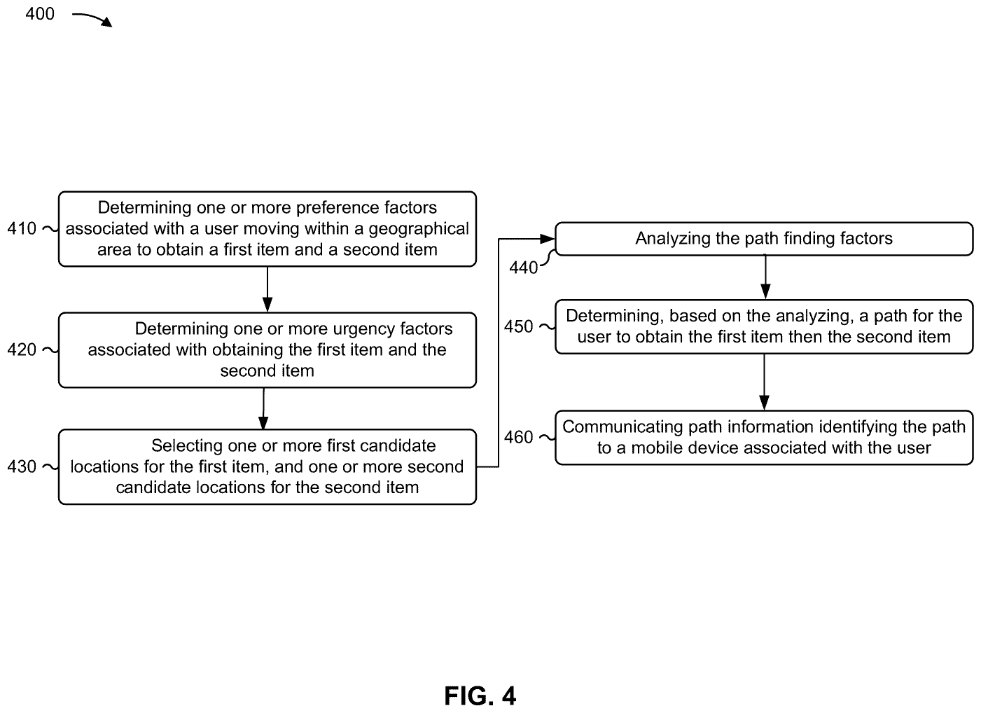

FIG. 4 is a flowchart of an example process 400 associated with using different data sources for determining and presenting the path for obtaining items by users. In some implementations, one or more process blocks of FIG. 4 may be performed by a path mapping system (e.g., path mapping system 110). In some implementations, one or more process blocks of FIG. 4 may be performed by another device or a group of devices separate from or including path mapping system 110, such as, such as a mobile device (e.g., mobile device 102). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include determining one or more preference factors associated with users moving within a geographical area to obtain a first item and a second item (block 410). For example, path mapping system 110 may determine one or more preference factors associated with users moving within a geographical area to obtain a first item and a second item, as described above.

In some implementations, the one or more preference factors associated with the user may include one or more of historical data regarding user behavior of the user in the geographical area, preference factors specified by the user, demographics of the user, and preference factors of the user associated with moving within the geographical area.

In some implementations, the one or more predicted benefits may include a relative cost benefit associated with use of the one or more routes, a relative time benefit associated with use of the one or more routes, and/or a relative benefit based on the consumption preference of the user.

Some implementations can further include determining the one or more routes based on historical data regarding user behavior of the user when the user obtained, at the level of urgency, the first item or the second item. Further, some implementations may determine the consumption preference further based on an order specifying that the first item is to be obtained before the second item.

As further shown in FIG. 4, process 400 may include determining one or more urgency factors associated with obtaining the first item and the second item (block 420). For example, path mapping system 110 may determine one or more urgency factors associated with obtaining the first item and the second item. In some implementations, the predicted benefits can be weighted based on the one or more predicted benefits identified based on the level of urgency.

As further shown in FIG. 4, process 400 may include selecting one or more first candidate locations for the first item, and one or more second candidate locations for the second item (block 430). For example, path mapping system 110 may select one or more first candidate locations for the first item, and one or more second candidate locations for the second item, as described above.

As further shown in FIG. 4, process 400 may include analyzing a predicted location of the path determining factors (block 440). For example, path mapping system 110 may determine based on the analyzing, the path for the user to obtain the first item then the second item, wherein the path is from the predicted location of the user to locations of the first item and the second item, as described above. In some implementations, the path is from the predicted location of the user to locations of the first item and the second item.

In some implementations, the geographical area is a first geographical area, and determining the one or more urgency factors may include accessing scheduling content associated with the user, to identify an event scheduled for the user at a second geographical area different from the first geographical area, determining a degree of relation between the event and obtaining the first item and a second item, and identifying the one or more urgency factors based on the degree of relation, the event scheduled, and the target date and time.

Some implementations may be configured such that determining the one or more urgency factors may include determining a distance between the first geographical location and the second geographical location. Additional implementations may further include analyzing social media content associated with the user to determine on one or more of the scheduling information, the degree of relation, the event scheduled, the target date and time, the one or more urgency factors, and the one or more preference factors. In some implementations, the degree of relation may be a first degree of relation, and the method may further include determining a second degree of relation between the first item and the second item, with determining the path being further based on the second degree of relation.

As further shown in FIG. 4, process 400 may include determining, based on the analyzing, a path for the user to obtain the first item then the second item, with the path being from the predicted location of the user to locations of the first item and the second item (block 450). For example, path mapping system 110 may determine, based on the analyzing, the path for the user to obtain the first item then the second item, with the path being from the predicted location of the user to locations of the first item and the second item, as described above.

As further shown in FIG. 4, process 400 may include communicating path information identifying the path to a mobile device associated with the user (block 460). For example, path mapping system 110 may communicate path information identifying the path to a mobile device associated with the user, as described above.

In some implementations, communicating the path information includes communicating the path information to cause the mobile device to output the path information highlighted by a heatmap overlay based on the one or more urgency factors, and the one or more preference factors. Implementations can include causing the mobile device to display the visualization of the path, with the one or more devices being further configured to cause the mobile device to display the visualization of a predicted benefit to the user per unit of distance travelled and with the visualization of the consumption strategy for the user.

Some implementations are further configured to determine the predicted benefit to the user per unit of distance based on one or more of a time associated with traveling the unit of distance, a cost required associated with traveling the unit of distance, and modes of travel available for traveling the unit of distance.

Implementations may further identify the respective characteristics of the first location and the second location, with the respective characteristics including an availability and a price of the first item and the second item, and may also perform a price comparison of the availability and the price of the first item and an availability and a price of the first item at a third location different from the first location and the second location, with determining the path being further based on the price comparison.

In some implementations, the one or more devices may be further configured to update the path based on a change to a price of at least one of the first item and the second item, and a price sensitivity of the user relative to the change to the price, with the one or more preferences including the price sensitivity of the user to a magnitude of changes to prices of at least one of the first item and the second item. In some implementations, the path finding factors may further include a congestion condition at the first location and the second location. Implementations may include traffic congestion as a traffic condition, and the one or more preferences associated with the user may include a preference to avoid traffic congestion during movement within the geographical area, and to determine the path, the one or more devices may be further configured to determine the path based on the congestion condition and the preference to avoid traffic congestion.

In some implementations, communicating the path information comprises communicating the path information to cause the mobile device to output the path information highlighted by a heatmap overlay based on the one or more urgency factors, and the one or more preference factors. In some implementations, the geographical area is a first geographical area, and wherein determining the one or more urgency factors includes accessing scheduling content, associated with the user, to identify an event scheduled for the user at a second geographical area different from the first geographical area, determining a degree of relation between the event and obtaining the first item and a second item, and identifying the one or more urgency factors based on the degree of relation, the event scheduled, and the target date and time.

In some implementations, determining the one or more urgency factors includes determining a distance between the first geographical location and the second geographical location.

In some implementations, process 400 includes analyzing social media information associated with the user to determine on one or more of the scheduling content, the degree of relation, the event scheduled, the target date and time, the one or more urgency factors, and the one or more preference factors. In some implementations, the degree of relation is a first degree of relation, and wherein the method further comprises determining a second degree of relation between the first item and the second item, wherein determining the path is further based on the second degree of relation.

In some implementations, the analyzing results in a length of the path decreasing as a level of urgency increases, and wherein the level of urgency is associated with obtaining the first item and the second item based on the one or more urgency factors. In some implementations, the one or more preference factors associated with the user includes one or more of historical data regarding user behavior of the user in the geographical area, preference factors specified by the user, demographics of the user, and preferences of the user associated with moving within the geographical area.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method, comprising:
determining, by a device, one or more preference factors associated with a user moving within a geographical area to obtain at least two items that including a first item and a second item;
determining, by the device, one or more urgency factors associated with obtaining the first item and the second item;
selecting, by the device, one or more first candidate locations for the first item, and one or more second candidate locations for the second item;
analyzing, by the device, path finding factors that include:
a predicted location of the user at a target date and time set for obtaining the first item and the second item,
the one or more urgency factors,
the one or more preference factors, and
the one or more first candidate locations and the one or more second candidate locations;
determining, by the device, based on analyzing the path finding factors, a path for the user to obtain the first item then the second item,
wherein the path is from the predicted location of the user to locations of the first item and the second item; and
communicating, by the device, path information identifying the path to a mobile device associated with the user.

2. The computer-implemented method of claim 1, wherein communicating the path information comprises:
communicating the path information to cause the mobile device to output the path information highlighted by a heatmap overlay based on the one or more urgency factors, and the one or more preference factors.

3. The computer-implemented method of claim 1, wherein the geographical area is a first geographical area, and
wherein determining the one or more urgency factors includes:
accessing scheduling information, associated with the user, to identify an event scheduled for the user at a second geographical area different from the first geographical area;
determining a degree of relation between the event and obtaining the first item and a second item; and
identifying the one or more urgency factors based on the degree of relation, the event scheduled, and the target date and time.

4. The computer-implemented method of claim 3, wherein determining the one or more urgency factors includes determining a distance between the first geographical area and the second geographical area.

5. The computer-implemented method of claim 3, computer-implemented method further comprising:
analyzing social media information associated with the user to determine on one or more of the scheduling information, the degree of relation, the event scheduled, the target date and time, the one or more urgency factors, and the one or more preference factors.

6. The computer-implemented method of claim 3, wherein the degree of relation is a first degree of relation,
wherein the computer-implemented method further comprises:
determining a second degree of relation between the first item and the second item, and
wherein determining the path is further based on the second degree of relation.

7. The computer-implemented method of claim 3, wherein the analyzing results in a length of the path decreasing as a level of urgency increases, and
wherein the level of urgency is associated with obtaining the first item and the second item based on the one or more urgency factors.

8. The computer-implemented method of claim 1, wherein the one or more preference factors associated with the user includes one or more of:
historical data regarding user behavior of the user in the geographical area,
preference factors specified by the user,
demographics of the user, and
preferences of the user associated with moving within the geographical area.

9. A system, comprising:
one or more devices configured to:
determine one or more preferences associated with a user moving within a geographical area to obtain at least two items including a first item and a second item;
determine a level of urgency regarding obtaining the first item and the second item from a first location and a second location, respectively, within a geographical area;
analyze, using a machine learning model, path finding factors relating to obtaining the first item and the second item;
wherein the factors include the first location relative to the user, the second location relative to the user, the level of urgency, the one or more preferences associated with the user, and respective characteristics of the first location and the second location;
determine, based on analyzing the path finding factors, a path for obtaining the first item and the second item from the first location and the second location within the geographical area; and
cause, a mobile device associated with the user, to display a visualization of the path.

10. The system of claim 9, wherein, to cause the mobile device to display the visualization of the path, the one or more devices are further configured to:
cause the mobile device to display the visualization of the path and a predicted benefit to the user per unit of distance travelled.

11. The system of claim 10, wherein the one or more devices are further configured to:
determine the predicted benefit to the user per unit of distance based on one or more of:
a time associated with traveling the unit of distance,
a cost required associated with traveling the unit of distance, and
modes of travel available for traveling the unit of distance.

12. The system of claim 9, wherein the one or more devices are further configured to:
identify the respective characteristics of the first location and the second location,
wherein the respective characteristics include an availability and a price of the first item and the second item;
perform a price comparison of the availability and the price of the first item and an availability and a price of the first item at a third location different from the first location and the second location; and
determine the path further based on the price comparison.

13. The system of claim 12, wherein the one or more devices are further configured to:
update the path based on:
a change to a price of at least one of the first item and the second item, and
a price sensitivity of the user relative to the change to the price,
wherein the one or more preferences include the price sensitivity of the user to a magnitude of changes to prices of at least one of the first item and the second item.

14. The system of claim 9, wherein the path finding factors further include a congestion condition at the first location and the second location.

15. The system of claim 14,
wherein the congestion condition includes traffic congestion,
wherein the one or more preferences associated with the user include a preference to avoid traffic congestion during movement within the geographical area, and
wherein, to determine the path, the one or more devices are further configured to:
determine the path based on the congestion condition and the preference to avoid traffic congestion.

16. A computer program product comprising:
one or more computer readable storage media, and program instructions collectively stored on the one or more computer readable storage media, the program instructions comprising:
program instructions to determine, for a user, a consumption preference and a level of urgency associated with obtaining a first good from a first location and a second good from a second location;
program instructions to analyze factors that include:
travel times determined for travel among locations that include a location of the user, the first location, and the second location,
the consumption preference, and
the level of urgency;
program instructions to determine, based on analyzing the factors, that the first good is to be obtained from the first location and that the second good is to be obtained from the second location;
program instructions to determine, based on analyzing the factors, one or more routes for the user to sequentially travel from the location of the user to the first location and the second location; and
program instructions to display a visualization that identifies the one or more routes along with one or more predicted benefits associated with the user utilizing the one or more routes.

17. The computer program product of claim 16, wherein the program instructions further comprise:
program instructions to determine the one or more predicted benefits that include one or more of:
a relative cost benefit associated with use of the one or more routes,
a relative time benefit associated with use of the one or more routes, and
a relative benefit based on the consumption preference of the user.

18. The computer program product of claim 17, wherein the program instructions to determine the one or more predicted benefits comprise:
program instructions to weight the one or more predicted benefits identified based on the level of urgency; and
program instructions to determine the one or more predicted benefits based on weighting the one or more predicted benefits identified based on the level of urgency.

19. The computer program product of claim 16, wherein the program instructions to determine the one or more routes comprise:
program instructions to determine the one or more routes based on historical data regarding user behavior of the user when the user obtained, at the level of urgency, the first good or the second good.

20. The computer program product of claim 16, wherein the program instructions to determine the consumption preference further comprise:
program instructions to determine the consumption preference further based on an order specifying that the first good is to be obtained before the second good.
